(19) United States
(12) Patent Application Publication
(10) Pub. No.: US 2015/0088656 A1
(43) Pub. Date: Mar. 26, 2015

(54) ACCESS POINT BROADCASTING OF ADVERTISEMENTS

(71) Applicant: QUALCOMM Incorporated, San Diego, CA (US)

(72) Inventor: Damanjit SINGH, San Diego, CA (US)

(73) Assignee: QUALCOMM Incorporated, San Diego, CA (US)

(21) Appl. No.: 14/034,929

(22) Filed: Sep. 24, 2013

(51) Int. Cl. G06Q 30/02; H04H 20/61

(52) U.S. Cl. CPC G06Q 30/0267; H04H 20/61
USPC 705/14.64

(57) ABSTRACT

Advertisements are presented to users of cell phones and other types of access terminals. For example, advertisements may be presented to a user when the user's access terminal is served by or camped on an access point such as a small cell. After obtaining an advertisement, an access point broadcasts a message that includes the advertisement. Advantageously, the advertisement may be broadcast via an HNB Name field defined in 3GPP. Consequently, upon receiving a broadcast including an HNB Name field, an access terminal will automatically display the advertisement included in the HNB Name field (e.g., instead of an HNB Name).

### BACKGROUND

This application relates generally to wireless communication and more specifically, but not exclusively, to broadcasting of advertisements by an access point.

A wireless communication network may be deployed to provide various types of services (e.g., voice, data, multimedia services, etc.) to users within a coverage area of the network. In some implementations, macro access points (e.g., corresponding to different macro cells) are distributed throughout a geographical area to provide wireless connectivity for access terminals (e.g., cell phones) that are operating within the area.

Some types of services provided to an access point include advertisements. For example, a video stream broadcast to an access terminal may include video-based advertisements. As another example, a web page sent to an access terminal may include a graphic-based advertisement.

Advertisers are always looking for more effective ways to present advertisements to prospective customers, including users who use access terminals. Consequently, there is a need for more effective ways to support advertisements in wireless communication networks.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to presenting advertisements to users of cell phones and other types of access terminals. In some implementations, advertisements are presented to a user when the user's access terminal is served by or camped on a small cell (e.g., a femto cell, a Home NodeB, a Home eNodeB, or other similar type of access point).

A network operator, user, or other entity configures a small cell to broadcast a message that comprises an advertisement. In some cases, advertisements are location dependent. For example, certain advertisements may be designated for broadcast only by certain small cells, depending on the location of each small cell. In some cases, advertisements are time dependent. For example, several advertisements may be downloaded to a small cell, whereby the small cell is configured to broadcast different advertisements at different times.

Upon receiving a broadcast message comprising an advertisement, an access terminal will display the advertisement either immediately or at a later point in time. As an example of the latter case, an access terminal in idle mode may store any advertisements that it receives via broadcasts messages. Once the access terminal performs cell selection or reselection, the access terminal may retrieve the stored advertisements and display them to the user.

In some implementations, an access point broadcasts an advertisement via a system information block (SIB). As a specific example, a small cell may include advertisement text in an HNB Name field defined by the 3^{rd} Generation Partnership Project (3GPP). In general, the term HNB refers to a Home NodeB or a Home eNodeB. However, the HNB Name field may be applicable to other similar types of small cells that may be referred to using different terminology (e.g., femto cells, etc.).

Upon receiving a broadcast HNB Name field that contains an advertisement instead of an HNB Name, an access terminal will automatically display the advertisement within the section of the display screen designated for display of the HNB Name. In this way, a small cell-specific advertisement may be automatically displayed by any access terminal within the coverage of the small cell.

The teachings herein may be embodied and/or practiced in different ways in different implementations.

In some aspects, an apparatus for communication in accordance with the teachings herein comprises: a processing system configured to identify, at an access point, an advertisement to be displayed by at least one access terminal associated with the access point; and a communication device configured to broadcast, from the access point, a message via an information block that is designated for carrying access point-specific information that is to be displayed, wherein the message comprises the advertisement.

In some aspects, a method of communication in accordance with the teachings herein comprises: identifying, at an access point, an advertisement to be displayed by at least one access terminal associated with the access point; and broadcasting, from the access point, a message via an information block that is designated for carrying access point-specific information that is to be displayed, wherein the message comprises the advertisement.

In some aspects, an apparatus for communication in accordance with the teachings herein comprises: means for identifying, at an access point, an advertisement to be displayed by at least one access terminal associated with the access point; and means for broadcasting, from the access point, a message via an information block that is designated for carrying access point-specific information that is to be displayed, wherein the message comprises the advertisement.

In some aspects, a computer-program product in accordance with the teachings herein comprises computer-readable medium comprising code for causing a computer to: identify, at an access point, an advertisement to be displayed by at least one access terminal associated with the access point; and broadcast, from the access point, a message via an information block that is designated for carrying access point-specific information that is to be displayed, wherein the message comprises the advertisement.

In some aspects, an apparatus for communication in accordance with the teachings herein comprises: a processing system configured to identify an advertisement, and further configured to identify an access point that is to broadcast the advertisement; and a communication device configured to send a message to the access point, wherein the message includes the advertisement, and wherein the message indicates that the advertisement is to be broadcast via an information block that is designated for carrying access point-specific information that is to be displayed.

In some aspects, a method of communication in accordance with the teachings herein comprises: identifying an advertisement; identifying an access point that is to broadcast the advertisement; and sending a message to the access point, wherein the message includes the advertisement, and wherein the message indicates that the advertisement is to be broadcast via an information block that is designated for carrying access point-specific information that is to be displayed.

In some aspects, an apparatus for communication in accordance with the teachings herein comprises: means for identifying an advertisement; means for identifying an access point that is to broadcast the advertisement; and means for sending a message to the access point, wherein the message includes the advertisement, and wherein the message indicates that the advertisement is to be broadcast via an information block that is designated for carrying access point-specific information that is to be displayed.

In some aspects, a computer-program product in accordance with the teachings herein comprises computer-readable medium comprising code for causing a computer to: identify an advertisement; identify an access point that is to broadcast the advertisement; and send a message to the access point, wherein the message includes the advertisement, and wherein the message indicates that the advertisement is to be broadcast via an information block that is designated for carrying access point-specific information that is to be displayed.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram illustrating several sample aspects of a communication system that supports access point broadcasting of advertisements;

FIG. 2 is a flowchart of several sample aspects of operations that may be performed in conjunction with broadcasting an advertisement;

FIG. 3 is a flowchart of several sample aspects of operations that may be performed in conjunction with receiving a broadcast message including an advertisement and displaying the advertisement;

FIG. 4 is flowchart of several sample aspects of operations that may be performed in conjunction with conditionally broadcasting an advertisement;

FIG. 5 is flowchart of several sample aspects of operations that may be performed in conjunction with location-based broadcasting of an advertisement;

FIG. 6 is flowchart of several sample aspects of operations that may be performed in conjunction with transmitting a page message to indicate broadcasting of an advertisement;

FIG. 7 is flowchart of several sample aspects of operations that may be performed in conjunction with trigger-based display of an advertisement;

FIG. 8 is a flowchart of several sample aspects of operations that may be performed in conjunction with sending an advertisement to an access point;

FIG. 9 is a simplified block diagram of several sample aspects of components that may be employed in communication nodes;

FIG. 10 is a simplified diagram of a wireless communication system;

FIG. 11 is a simplified diagram of a wireless communication system including small cells;

FIG. 12 is a simplified diagram illustrating coverage areas for wireless communication;

FIG. 13 is a simplified block diagram of several sample aspects of communication components; and

FIG. 14-FIG. 16 are simplified block diagrams of several sample aspects of apparatuses configured to respectively support broadcast and display of advertisements as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The disclosure relates in some aspects to access point-centric broadcasting of advertisement. An access point such as a small cell (e.g., HNB or HeNB) identifies an advertisement to be presented to any users within the coverage of the access point and broadcasts that advertisement over a broadcast channel. In some implementations, the access point includes the advertisement in an HNB Name field of a SIB that is broadcast by the access point.

Any access terminals such as cell phones within the broadcast coverage of the access point will receive the broadcast including the advertisement. Advantageously, an access terminal may receive this advertisement even when the access terminal is in idle mode. Upon receipt of the advertisement, the access terminal displays the advertisement to a user. In implementations where the advertisement is received via an HNB Name field, the access terminal will automatically display the advertisement within the section of the display screen designated for display of the HNB Name. In this way, an advertisement designated for a specific access point or specific access points (as opposed to a network-wide broadcast of an advertisement) may be automatically displayed by any access terminals within the coverage of the access point(s).

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim.

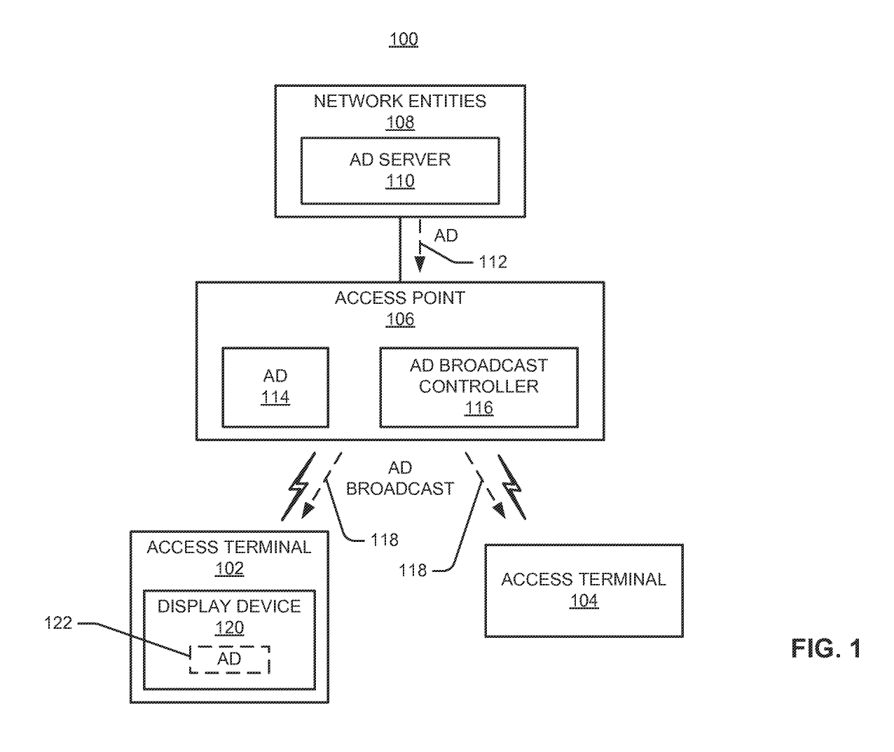

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points in the system 100 provide access to one or more services (e.g., network connectivity) for one or more wireless terminals that may be installed within or that may roam throughout a coverage area of the system 100. For example, at various points in time the access terminal 102 may connect to an access point 106 or some other access point in the system 100 (not shown). Similarly, the access terminal 104 may connect to the access point 106 or some other access point.

Each of the access points may communicate with one or more network entities (represented, for convenience, by the network entities 108), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 108 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

Some of the access points in the system 100 may comprise low-power access points. Various types of low-power access points may be employed in a given system. For example, low-power access points may be implemented as or referred to as femto cells, femto access points, small cells, femto nodes, home NodeBs (HNBs), home eNodeBs (HeNBs), access point base stations, pico cells, pico nodes, or micro cells. Typically, low-power access points connect to the Internet via a broadband connection (e.g., a digital subscriber line (DSL) router, a cable modem, or some other type of modem) that provides a backhaul link to a mobile operator's network. Thus, a low-power access point deployed in a user's home or business provides mobile network access to one or more devices via the broadband connection.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femto cells may have a maximum transmit power of 20 dBm or less. In some implementations, low-power access points such as pico cells may have a maximum transmit power of 24 dBm or less. It should be appreciated, however, that these or other types of low-power access points may have a higher or lower maximum transmit power in other implementations (e.g., up to 1 Watt in some cases, up to 10 Watts in some cases, and so on).

For convenience, low-power access points may be referred to simply as small cells in the discussion that follows. Thus, it should be appreciated that any discussion related to small cells herein may be equally applicable to low-power access points in general (e.g., to femto cells, to micro cells, to pico cells, etc.).

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

In the example of FIG. 1, an advertisement (AD) server 110 sends an AD to the access point 106 as represented by the dashed line 112. The access point 106 stores the AD in a memory as represented by the AD 114. The access point 106 includes an AD broadcast controller 116 that controls broadcasting of the AD 114. For example, the AD broadcast controller 116 may determine one or more of: whether to broadcast the AD 114, when to broadcast the AD 114, or how (e.g., in which broadcast channel) to broadcast the AD 114.

At some point in time, the access point 106 broadcasts the AD 114 as represented by the dashed lines 118. As discussed herein, in some implementations, the access point 106 includes the AD 114 in an HNB Name field of a SIB that is broadcast by the access point 106. For example, a closed subscriber group (CSG) cell or a hybrid cell may broadcast an HNB Name in free text format. An HNB Name defined in 3GPP may include 48×8 bits which, if each character for an advertisement takes 1 byte (8 bits), advertisements having up to 48 characters may be supported.

It should be appreciated that other implementations may use information elements (IEs) other than the HNB Name. For example, other IEs defined by a communication standard may be used to carry advertisements or new IEs may be defined to carry advertisements.

An access terminal within the coverage area of the access point 106 may receive any broadcasts by the access point 106. For example, the access terminal 102 may receive the AD broadcast 118 while the access terminal is in idle mode, connected mode (e.g., connected to the access point 106), or some other suitable type of mode. As an example of the first case, when the access terminal 102 camps on the access point 106, the access terminal 102 will read the SIBs broadcast by the access point 106. As an example of the second case, when the access terminal 102 is being served by the access point 106, the access terminal 102 will receive messages sent by the access point 106.

Upon receiving the AD broadcast 118, the access terminal 102 displays the AD on a display screen of a display device 120 as represented by AD 122.

In implementations where the access terminal 102 receives an advertisement via an HNB Name field, the access terminal 102 may display the AD 122 within a section of the display screen reserved for display of the HNB name. Advantageously, this advertisement may be displayed as long as the display screen is active (e.g., similar to the display of the network operator name). Similar results also could be achieved through the use of some other SIB field or IE designated for this purpose.

Under conventional practice, an HNB Name, if available, is presented to a user during manual CSG selection. The presentation of the HNB Name enables a user to choose the correct CSG identity when performing a manual CSG identity selection. Thus, in accordance with the teachings herein, this automatic presentation of the HNB Name may be re-tasked and used for presentation of an advertisement.

Under conventional practice, an HNB Name is configurable by a network operator or the HNB (or HeNB) hosting party, at the discretion of the network operator. Consequently, the HNB Name may readily be modified to accommodate an advertisement in accordance with the teachings herein.

Such an advertisement scheme may be used to display a variety of advertisement messages. In some aspects, an advertisement message may be used to advertise goods or services. For example, a retail franchise may pay a network carrier to advertise at each of the franchise locations at which the network carrier provides access points (e.g., small cells). The manner of this advertisement may advantageously be location-based. As one example, a given advertisement may be broadcast by all access points nationwide. As another example, a given advertisement (e.g., a coupon) may be broadcast only by those access points located within a specified shopping mall or within specified shopping malls.

In some aspects, an advertisement message may be used to show support for a particular issue or cause. For example, political advertisements may be broadcast by specified access points (e.g., depending on the location of those access points).

In some aspects, an advertisement message may be used to provide notification of an emergency. For example, an earthquake, flood, hurricane, or fire warning may be broadcast by specified access points (e.g., depending on the location of those access points).

As mentioned above, an advertisement may be location-based. For example, upon determining the location of an access point (e.g., determined based on a message received from the access point), an advertisement server may send an advertisement that is selected based on that location to the access point.

An advertisement also may be time-based. For example, upon determining a current time at an access point (e.g., based on a message from the access point), an advertisement server may send an advertisement that is selected based on that time to the access point.

An advertisement also may be user-based. For example, upon determining the identity of a user who has registered at an access point (e.g., based on a message from the access point), an advertisement server may send an advertisement that is selected based on that user to the access point.

Several advantages may be achieved through the use of the disclosed advertisement scheme. Since a user tends to look at the screen of his or her access terminal quite often (e.g., to check the time, to check for messages, to make or receive a call, etc.), the user will likely see any advertisement that replaces the HNB Name that may have otherwise been displayed by the access terminal. Accordingly, the advertising scheme described herein may provide a very effective form of advertising.

In addition, the use of a scheme that uses SIBs to send advertisements may have relatively little impact on the battery life of the access terminal. This is because SIBs are typically read only in conjunction with cell selection or cell reselection.

Moreover, any impact on communication standards compliance may be minimal or avoided entirely. For example, existing mechanisms may be employed to wake-up an access terminal to read SIBs when the SIBs are updated. Also, the displaying of the HNB Name may be strictly enforced by network operators, thereby ensuring that the desired advertisements will be displayed on access terminals.

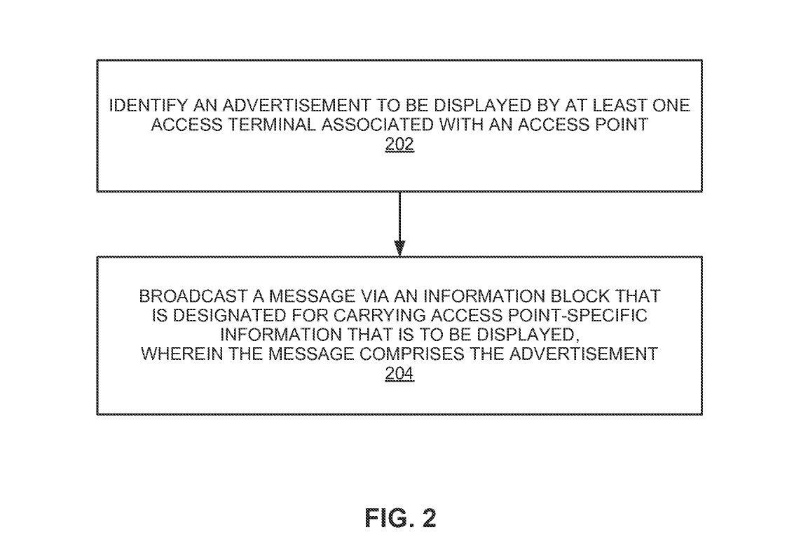

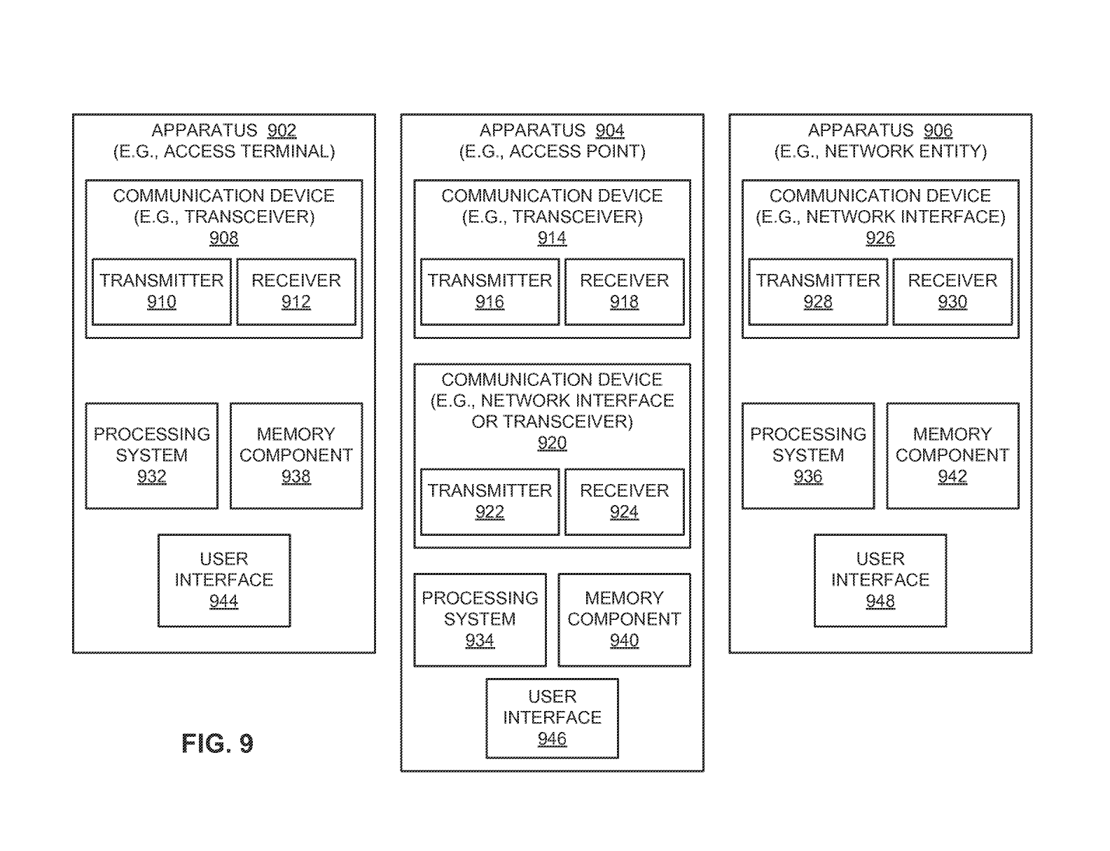

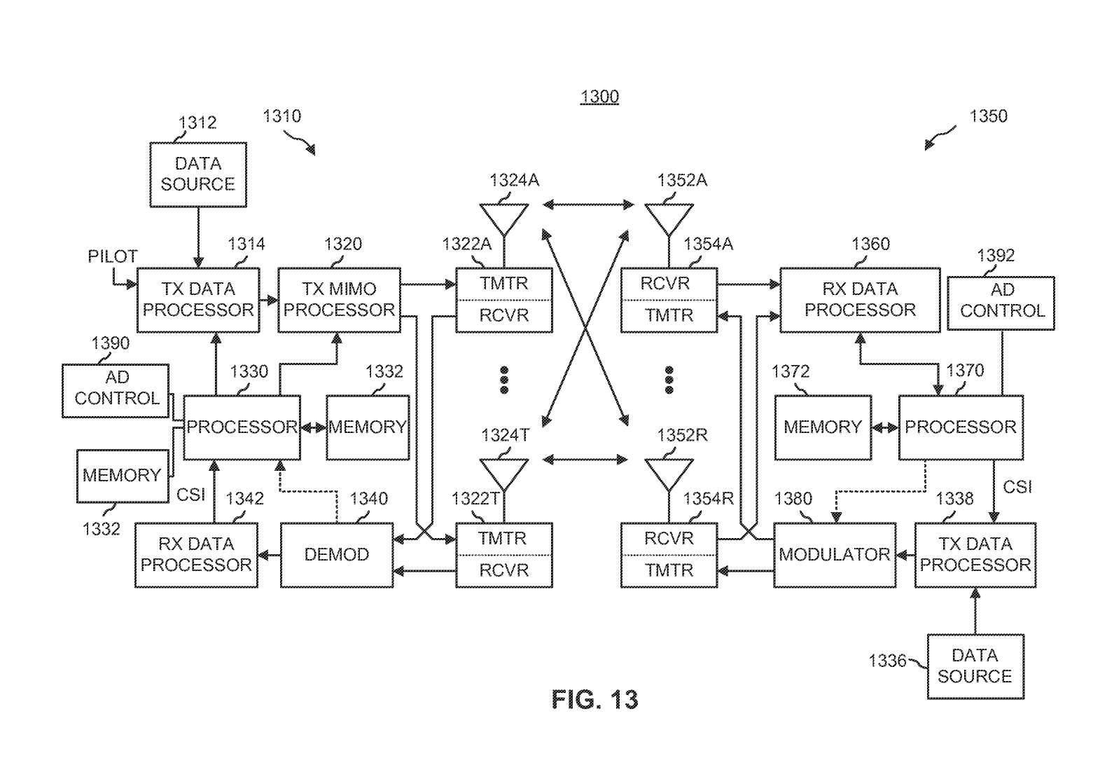

Sample operations relating to broadcasting and displaying advertisements in accordance with the teachings herein will be described in more detail in conjunction with the flowcharts of FIGS. 2-7. For convenience, the operations of FIGS. 2-7 (or any other operations discussed or taught herein) may be described as being performed by specific components (e.g., components of FIG. 1, FIG. 9, or FIGS. 13-16). It should be appreciated, however, that these operations may be performed by other types of components and may be performed using a different number of components. It also should be appreciated that one or more of the operations described herein may not be employed in a given implementation.

FIG. 2 illustrates an example of operations that may be performed by an access point or some other suitable entity in conjunction with broadcasting an advertisement. In a typical implementation, the access point comprises a small cell.

As represented by block 202, an advertisement to be displayed by at least one access terminal associated with an access point is identified. For example, the access point may independently determine which advertisement is to be sent via a particular broadcast channel. In this way, if desired, unique advertisements may be designated for different access points in a system. Moreover, in this case, an access point can determine whether and when to broadcast an advertisement. This access point-centric approach stands in contrast to conventional advertising schemes where an advertisement is included in a stream or data set originating in an advertisement server, and where the stream or data set is merely passed on by an access point to a destination access terminal.

The identification of an advertisement may be accomplished in different ways in different implementations. In some implementations, the identification of the advertisement may comprise receiving an advertisement (e.g., from an advertisement server) along with an indication that the advertisement is to be broadcast by the access point. In some implementations, the identification of the advertisement may comprise identifying a stored advertisement (e.g., stored locally at the access point or remotely from the access point) that the access point will broadcast. In some implementations, the identification of the advertisement may comprise: receiving an advertisement; storing the received advertisement; and determining that the stored advertisement is to be broadcast via an information block.

As represented by block 204, a message comprising the advertisement is broadcast via an information block that is designated for carrying access point-specific information that is to be displayed. In a typical implementation, the advertisement is broadcast via a broadcast channel that can be received by access terminals operating in idle mode and/or connected mode.

The broadcasting of the message may be accomplished in different ways in different implementations. In some aspects, the broadcasting of the message may comprise broadcasting a system information block comprising the message. In implementations where the advertisement is broadcast via a system information block (SIB), the advertisement may be included in an HNB Name field of the SIB. For example, rather than inserting the HNB Name in this SIB field, the access point may insert advertisement text in this SIB field. In some aspects, the broadcasting of the message may comprise broadcasting the message independent of any broadcast of user data.

The broadcast channel may take different forms in different implementations. In some aspects, the broadcast channel may comprise a control channel. In some aspects, the broadcast channel may comprise a channel that is not used for transmission of user data.

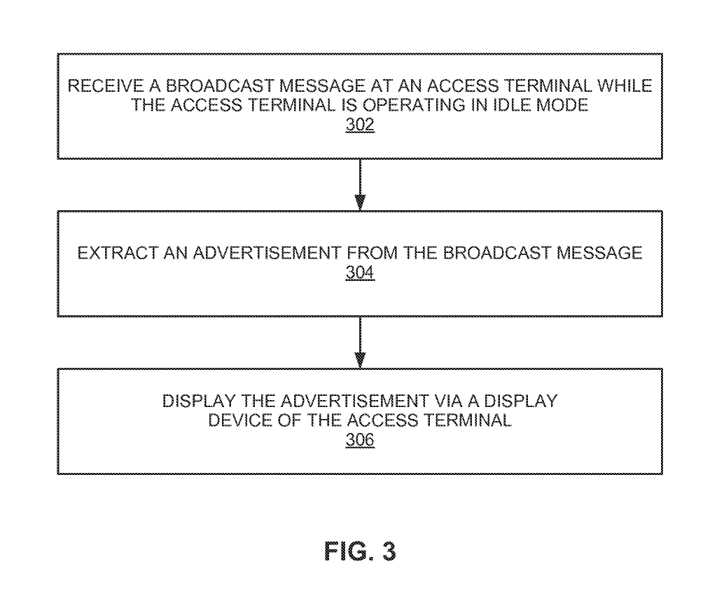

FIG. 3 illustrates an example of operations that may be performed by an access terminal in conjunction with receiving a broadcast advertisement and displaying the advertisement. This flowchart relates to one particular scenario where the access terminal may advantageously receive an advertisement during idle mode.

As represented by block 302, a broadcast message is received at an access terminal while the access terminal is operating in idle mode. For example, the access terminal may monitor for broadcasts from a given access point while the access terminal is camped on that access point.

As mentioned above, the broadcast message may take various forms. In some aspects, the broadcast message may comprise a system information block (SIB) that includes the advertisement. In some aspects, the SIB may comprise an HNB Name field that includes the advertisement. In some aspects, the broadcast message may comprise an information block that is designated for carrying access point-specific information that is to be displayed. In some aspects, the broadcast message may comprise a message broadcast independent of any broadcast of user data. In some aspects, the broadcast message may be received via a broadcast channel. In some aspects, the broadcast message may be received via a channel that is not used for transmission of user data. In some aspects, the broadcast message may be received via a control channel.

As represented by block 304, an advertisement is extracted from the broadcast message. For example, in implementations where the advertisement is broadcast via a SIB, the advertisement may be read from that SIB.

As represented by block 306, the advertisement is displayed via a display device of the access terminal. For example, the advertisement may be displayed within a section of the display screen that is designated for such advertisements. As another example, in implementations where the advertisement is included in an HNB Name field, the advertisement may be displayed within a section of the display screen that is designated for displaying the HNB Name.

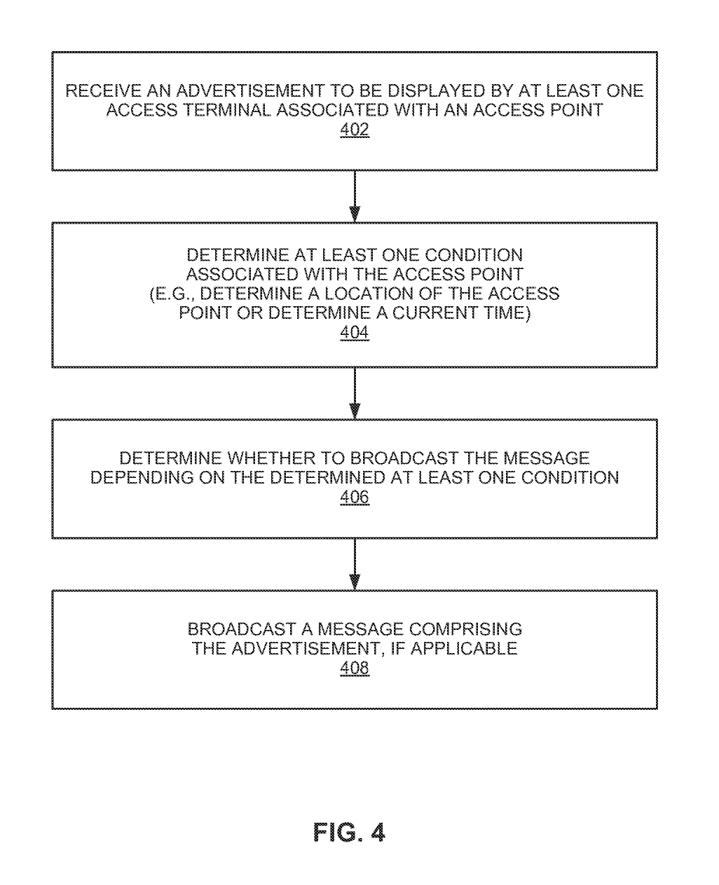

FIG. 4 illustrates an example of operations that may be performed by an access point or some other suitable entity in conjunction with conditional broadcasting of an advertisement. In a typical implementation, the access point comprises a small cell.

As represented by block 402, an advertisement to be displayed by at least one access terminal associated with an access point is received. In some aspects, the operations of block 402 may be similar to the operations described above with reference to block 202. For example, an access point may receive an advertisement from an advertisement server.

As represented by block 404, at least one condition associated with the access point is determined. For example, a location of the access point may be determined. As another example, a current time may be determined.

As represented by block 406, a determination may be made as to whether to broadcast a message comprising the advertisement received at block 402. This determination depends on the at least one condition determined at block 404.

As one example, the display of the advertisement may be restricted to certain locations. Thus, if the location of the access point corresponds to one of these locations, a determination may be made at block 406 to broadcast the advertisement. Accordingly, in some aspects, a determination of whether to broadcast the message may depend on a location determined at block 404.

As another example, the display of the advertisement may be restricted to certain times. Thus, if the current time at the access point corresponds to one of these times, a determination may be made at block 406 to broadcast the advertisement. Accordingly, in some aspects, a determination of whether to broadcast the message may depend on a current time determined at block 404.

As represented by block 408, depending on the determination of block 406, a message comprising the advertisement may be broadcast. In some aspects, the operations of block 408 may be similar to the operations described above with reference to block 206.

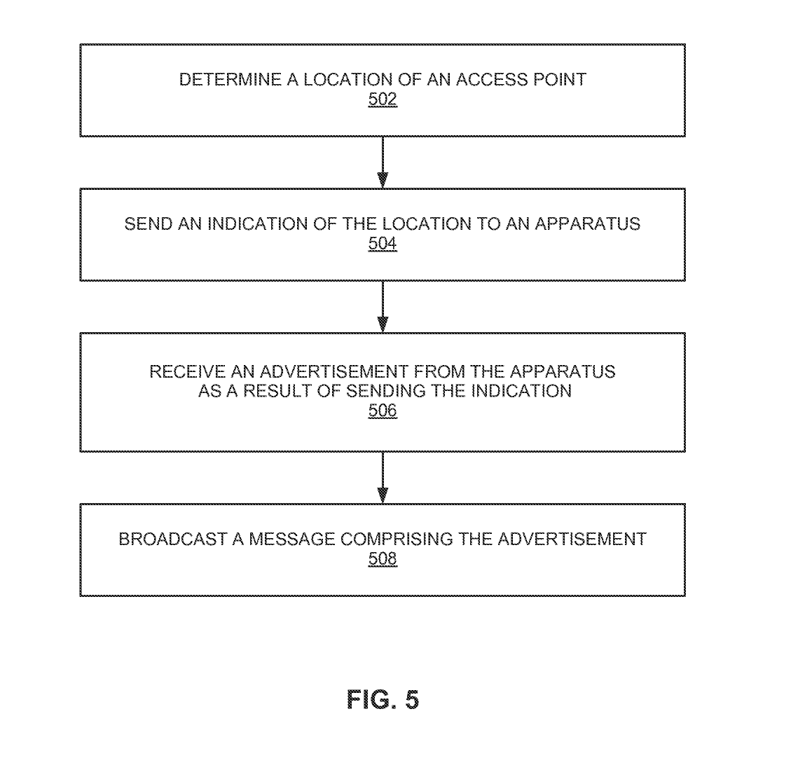

FIG. 5 illustrates an example of operations that may be performed by an access point or some other suitable entity in conjunction with location-based broadcasting of an advertisement. In a typical implementation, the access point comprises a small cell.

As represented by block 502, a location of an access point is determined. For example, an access point may use a location detection component (e.g., a global positioning system (GPS) receiver) to determine its location. As another example, an access point may receive location information from another device (e.g., a nearby access terminal that has triangulated its own location may send corresponding location information to the access point). As another example, an access point may be configured with information indicative of its location (e.g., by a user who deploys a small cell).

As represented by block 504, an indication of the location determined at block 502 is sent to an apparatus. For example, an access point may send its location information to an advertisement server.

As represented by block 506, an advertisement is received from the apparatus as a result of sending the indication at block 504. For example, the display of certain advertisements may be restricted to certain locations. Thus, the particular advertisement sent by an advertisement server may depend on the location of the access point.

As represented by block 508, a message comprising the advertisement received at block 506 is broadcast. In some aspects, the operations of block 508 may be similar to the operations described above with reference to block 206.

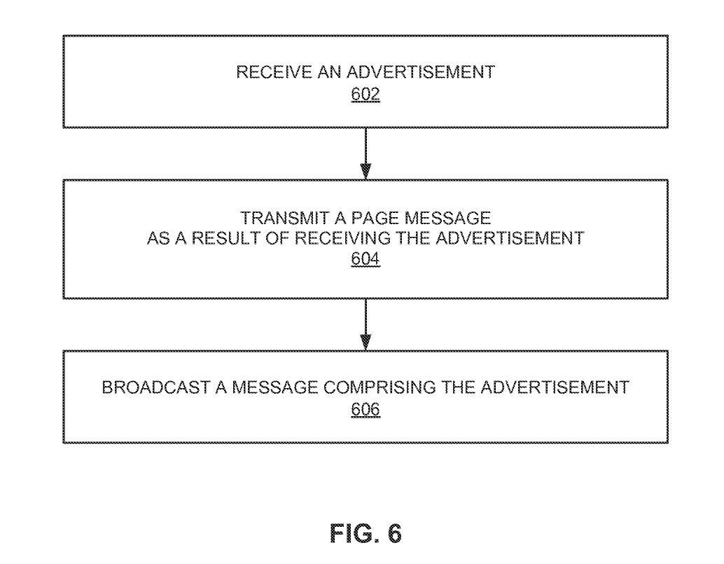

FIG. 6 illustrates an example of operations that may be performed by an access point or some other suitable entity in conjunction with transmitting a page message to indicate the broadcasting of an advertisement. In a typical implementation, the access point comprises a small cell.

As represented by block 602, an advertisement is received. In some aspects, the operations of block 602 may be similar to the operations described above with reference to block 202. For example, an access point may receive an advertisement from an advertisement server.

As represented by block 604, a page message is transmitted as a result of receiving the advertisement at block 602. In some aspects, the page message indicates a change in the broadcast channel used by the access point for broadcasting the message. Consequently, the transmission of the page message may serve as an indication that an advertisement is to be broadcast. For example, any nearby access terminals that receive the page message will be alerted to monitor for upcoming broadcasts by the access point. Upon receiving these broadcasts, the access terminals will receive the advertisement.

As represented by block 606, a message comprising the advertisement received at block 602 is broadcast. In some aspects, the operations of block 606 may be similar to the operations described above with reference to block 206.

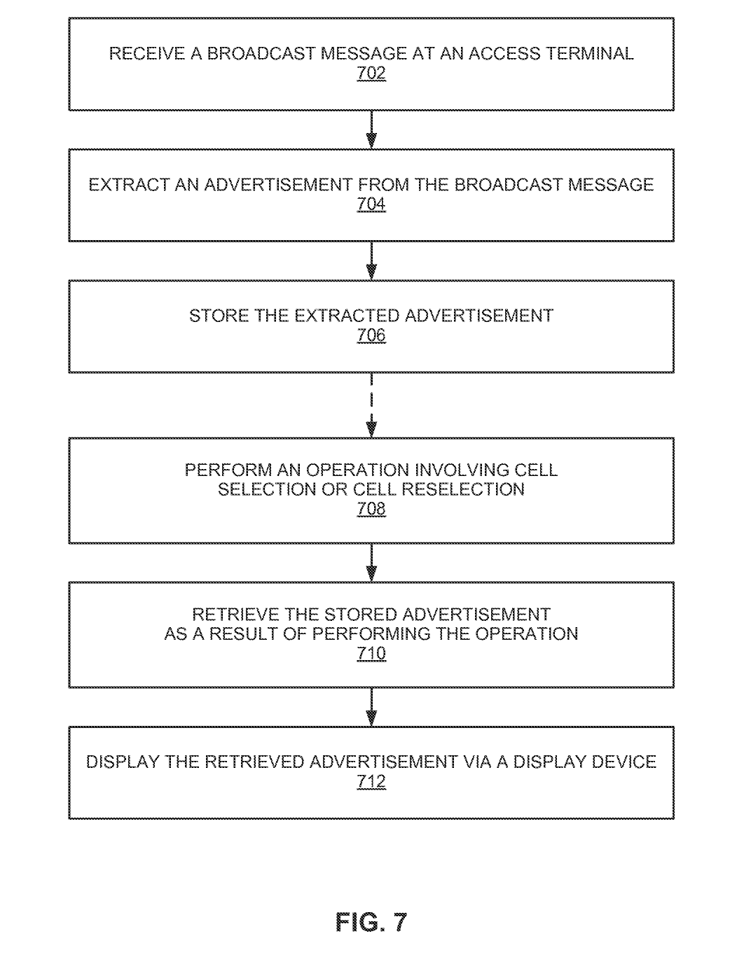

FIG. 7 illustrates an example of operations that may be performed in conjunction with a triggered display of an advertisement. The operations of FIG. 7 may be performed by an access terminal or some other suitable entity or entities.

As represented by block 702, a broadcast message is received at an access terminal. For example, an access terminal operating in idle mode, connected mode, or some other mode may monitor the broadcast channels of a nearby access point.

As represented by block 704, an advertisement is extracted from the broadcast message received at block 702. In some aspects, the operations of block 704 may be similar to the operations described above with reference to block 304.

As represented by block 706, the advertisement extracted at block 704 is stored. For example, the access terminal may store the advertisement in a local memory.

As represented by block 708, at some later point in time, an operation involving cell selection or cell reselection is performed. For example, while operating in idle mode, an access terminal may reselect to a nearby access point.

As represented by block 710, as a result of performing the operation of block 707, the advertisement stored at block 706 is retrieved. For example, the access terminal may read the advertisement from a local memory.

As represented by block 712, the advertisement retrieved at block 710 is displayed via a display device. In some aspects, the operations of block 712 may be similar to the operations described above with reference to block 306.

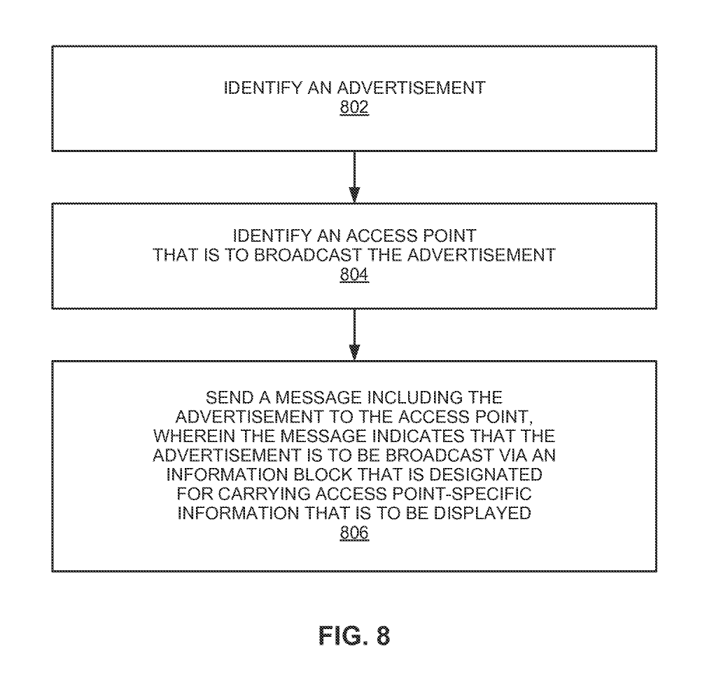

FIG. 8 illustrates an example of operations that may be performed by an entity in conjunction with sending an advertisement to an access point. In a sample implementation, the entity is a network entity (e.g., comprising an advertisement server).

As represented by block 802, an advertisement is identified. For example, upon determining that one or more access points are to broadcast an advertisement, a network entity may identify which advertisement is to be broadcast. To this end, the network entity may search a storage device (e.g., locally or remotely) to locate the advertisement, then extract the advertisement from the storage device.

In some implementations, the identification of an advertisement is time dependent. In this case, certain advertisements may be designated for display at certain times. Thus, the advertisement identified at block 802 may depend on the current time, an expected advertisement broadcast time, or some other timing criteria. For example, some advertisements may be displayed during working hours, while other advertisements are displayed on weekends.

In some implementations, the identification of an advertisement is location dependent. In this case, certain advertisements may be designated for display at certain locations. Thus, the advertisement identified at block 802 may depend on the location at which an advertisement is desired to be displayed. For example, some advertisements may be displayed at a chain of retail stores, some advertisements may be displayed at one or more shopping malls, some advertisements may be displayed at users' home, and so on.

Acquisition of an advertisement may be accomplished in different ways in different implementations. In some implementations, an entity receives advertisement information (e.g., from an advertisement server or a user) and stores the advertisement information locally. In some implementations, an entity retrieves advertisement information from a storage device (e.g., a remote database). In some implementations, an entity includes a user interface that enables a user to input an advertisement.

As represented by block 804, an access point that is to broadcast the advertisement is identified. For example, upon determining that one or more access points are to broadcast an advertisement, the network entity may access a list of access points, then select from that list any access points that are capable of broadcasting the advertisement in a desired manner. To this end, the network entity may search a storage device (e.g., locally or remotely) to locate the access point(s), then extract information (e.g., an identifier) about the access point(s) from the storage device.

In some implementations, the identification of an access point is location dependent. As mentioned above, certain advertisements may be designated for display at certain locations. Thus, the access point identified at block 804 may depend on the location at which an advertisement is desired to be displayed. For example, access points at a chain of retail stores may be identified, access points at one or more shopping malls may be identified, access points at users' home may be identified, and so on.

In some implementations, the identification of an access point is time dependent. In this case, certain access points may be designated for displaying advertisements at certain times. Thus, the access point identified at block 804 may depend on the current time, an expected advertisement broadcast time, or some other timing criteria. For example, access points at work locations may be used to display advertisements during working hours, while other access points are used to display advertisements on weekends.

As represented by block 806, a message that includes the advertisement identified at block 802 is sent to the access point identified at block 804. For example, a network entity may retrieve advertisement information (e.g., text) and access point identifier information from a storage device, formulate a message including the advertisement information and the identifier information, and then send the message to the access point via an appropriate delivery mechanism (e.g., a backhaul).

As discussed herein, the message indicates that the advertisement is to be broadcast via an information block that is designated for carrying access point-specific information that is to be displayed. This indication may be explicit or implicit. In the former case, the message may include an indication that indicates that the advertisement is to be broadcast in this manner. In the latter case, the message may be of a form (e.g., a specific message type) that indicates that the advertisement is to be broadcast in this manner.

FIG. 9 illustrates several sample components (represented by corresponding blocks) that may be incorporated into an apparatus 902, an apparatus 904, and an apparatus 906 (e.g., corresponding to an access terminal, an access point, and a network entity, respectively) to advertisement-related operations as taught herein. It should be appreciated that these components may be implemented in different types of apparatuses in different implementations (e.g., in an application-specific integrated circuit (ASIC), in a system-on-a-chip (SoC), etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 902 and the apparatus 904 each include at least one wireless communication device (represented by the communication devices 908 and 914 (and the communication device 920 if the apparatus 904 is a relay)) for communicating with other nodes via at least one designated radio access technology. Each communication device 908 includes at least one transmitter (represented by the transmitter 910) for transmitting and encoding signals (e.g., messages, indications, information, and so on) and at least one receiver (represented by the receiver 912) for receiving and decoding signals (e.g., messages, indications, information, pilots, and so on). Similarly, each communication device 914 includes at least one transmitter (represented by the transmitter 916) for transmitting signals (e.g., messages, indications, information, pilots, and so on) and at least one receiver (represented by the receiver 918) for receiving signals (e.g., messages, indications, information, and so on). If the apparatus 904 is a relay access point, each communication device 920 may include at least one transmitter (represented by the transmitter 922) for transmitting signals (e.g., messages, indications, information, pilots, and so on) and at least one receiver (represented by the receiver 924) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 904 comprises a network listen module.

The apparatus 906 (and the apparatus 904 if it is not a relay access point) includes at least one communication device (represented by the communication device 926 and, optionally, 920) for communicating with other nodes. For example, the communication device 926 may comprise a network interface that is configured to communicate with one or more network entities via a wire-based or wireless backhaul. In some aspects, the communication device 926 may be implemented as a transceiver configured to support wire-based or wireless signal communication. This communication may involve, for example, sending and receiving: messages, parameters, or other types of information. Accordingly, in the example of FIG. 9, the communication device 926 is shown as comprising a transmitter 928 and a receiver 930. Similarly, if the apparatus 904 is not a relay access point, the communication device 920 may comprise a network interface that is configured to communicate with one or more network entities via a wire-based or wireless backhaul. As with the communication device 926, the communication device 920 is shown as comprising a transmitter 922 and a receiver 924.

The apparatuses 902, 904, and 906 also include other components that may be used in conjunction with advertisement-related operations as taught herein. The apparatus 902 includes a processing system 932 for providing functionality relating to, for example, receiving and processing an advertisement broadcast by an access point and for providing other processing functionality. The apparatus 904 includes a processing system 934 for providing functionality relating to, for example, broadcasting an advertisement as taught herein and for providing other processing functionality. The apparatus 906 includes a processing system 936 for providing functionality relating to, for example, serving advertisements and controlling advertisement broadcast and display as taught herein and for providing other processing functionality. The apparatuses 902, 904, and 906 include memory devices 938, 940, and 942 (e.g., each including a memory device), respectively, for maintaining information (e.g., information indicative of reserved resources, thresholds, parameters, and so on). In addition, the apparatuses 902, 904, and 906 include user interface devices 944, 946, and 948, respectively, for providing indications (e.g., audible and/or visual indications) to a user and/or for receiving user input (e.g., upon user actuation of a sensing device such a keypad, a touch screen, a microphone, and so on).

For convenience, the apparatus 902 is shown in FIG. 9 as including components that may be used in the various examples described herein. In practice, the illustrated blocks may have different functionality in different aspects. For example, functionality of the block 934 for supporting the implementation of FIG. 4 may be different as compared to functionality of the block 934 for supporting the implementation of FIG. 5.

The components of FIG. 9 may be implemented in various ways. In some implementations, the components of FIG. 9 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 908, 932, 938, and 944 may be implemented by processor and memory component(s) of the apparatus 902 (e.g., by execution of appropriate code and/or by appropriate configuration of processor components). Similarly, some or all of the functionality represented by blocks 914, 920, 934, 940, and 946 may be implemented by processor and memory component(s) of the apparatus 904 (e.g., by execution of appropriate code and/or by appropriate configuration of processor components). Also, some or all of the functionality represented by blocks 926, 936, 942, and 948 may be implemented by processor and memory component(s) of the apparatus 906 (e.g., by execution of appropriate code and/or by appropriate configuration of processor components).

As discussed above, the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with other types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

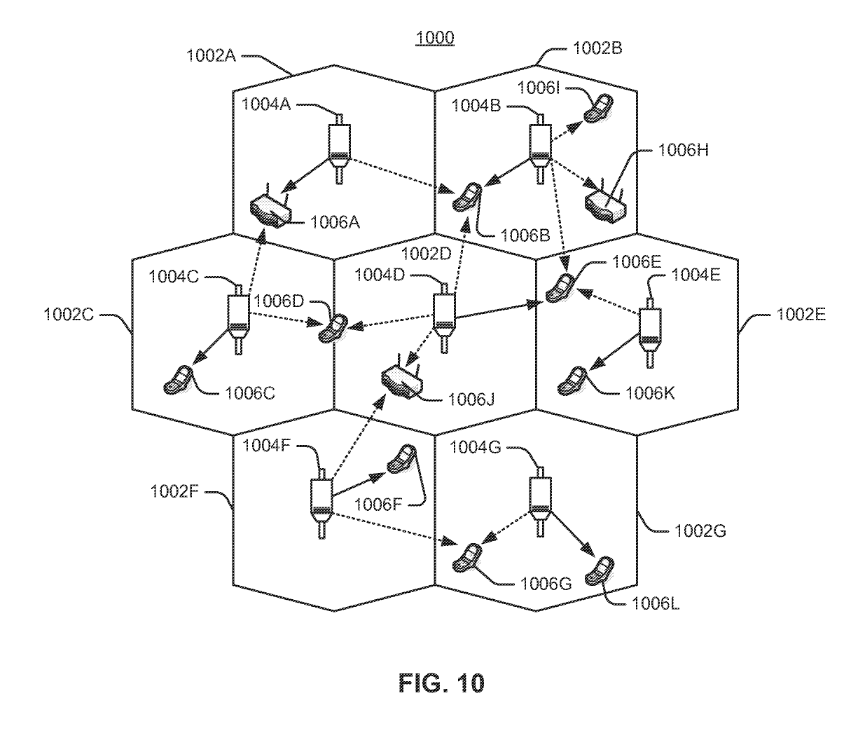

FIG. 10 illustrates a wireless communication system 1000, configured to support a number of users, in which the teachings herein may be implemented. The system 1000 provides communication for multiple cells 1002, such as, for example, macro cells 1002A-1002G, with each cell being serviced by a corresponding access point 1004 (e.g., access points 1004A-1004G). As shown in FIG. 10, access terminals 1006 (e.g., access terminals 1006A-1006L) may be dispersed at various locations throughout the system over time. Each access terminal 1006 may communicate with one or more access points 1004 on a forward link (FL) and/or a reverse link (RL) at a given moment, depending upon whether the access terminal 1006 is active and whether it is in soft handoff, for example. The wireless communication system 1000 may provide service over a large geographic region. For example, macro cells 1002A-1002G may cover a few blocks in a neighborhood or several miles in a rural environment.

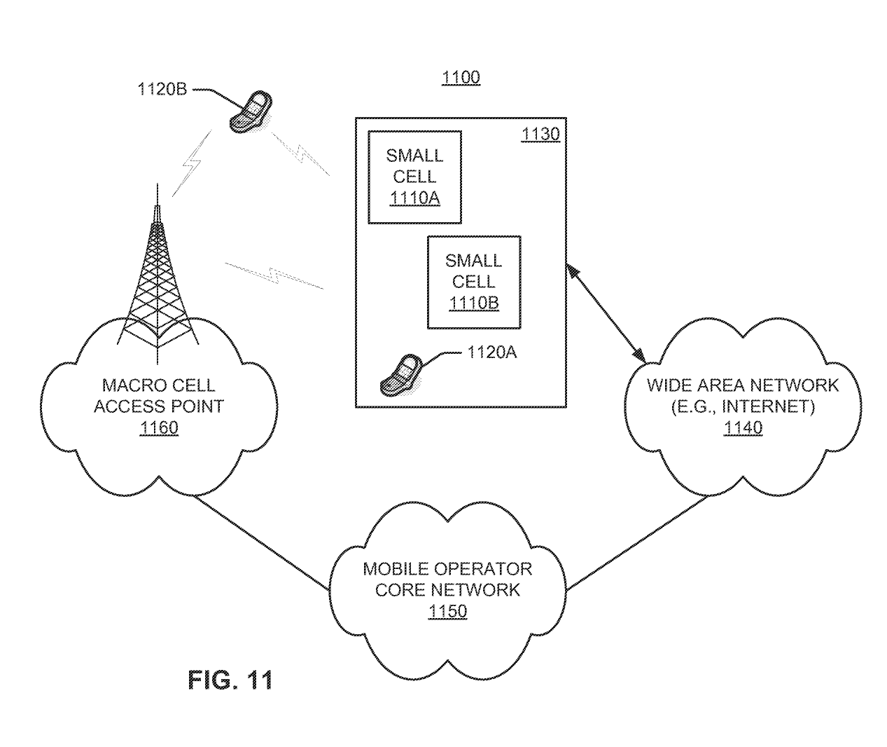

FIG. 11 illustrates an example of a communication system 1100 where one or more small cells are deployed within a network environment. Specifically, the system 1100 includes multiple small cells 1110 (e.g., small cells 1110A and 1110B) installed in a relatively small scale network environment (e.g., in one or more user residences 1130). Each small cell 1110 may be coupled to a wide area network 1140 (e.g., the Internet) and a mobile operator core network 1150 via a DSL router, a cable modem, a wireless link, or other connectivity means (not shown). As will be discussed below, each small cell 1110 may be configured to serve associated access terminals 1120 (e.g., access terminal 1120A) and, optionally, other (e.g., hybrid or alien) access terminals 1120 (e.g., access terminal 1120B). In other words, access to small cells 1110 may be restricted whereby a given access terminal 1120 may be served by a set of designated (e.g., home) small cell(s) 1110 but may not be served by any non-designated small cells 1110 (e.g., a neighbor's small cell 1110).

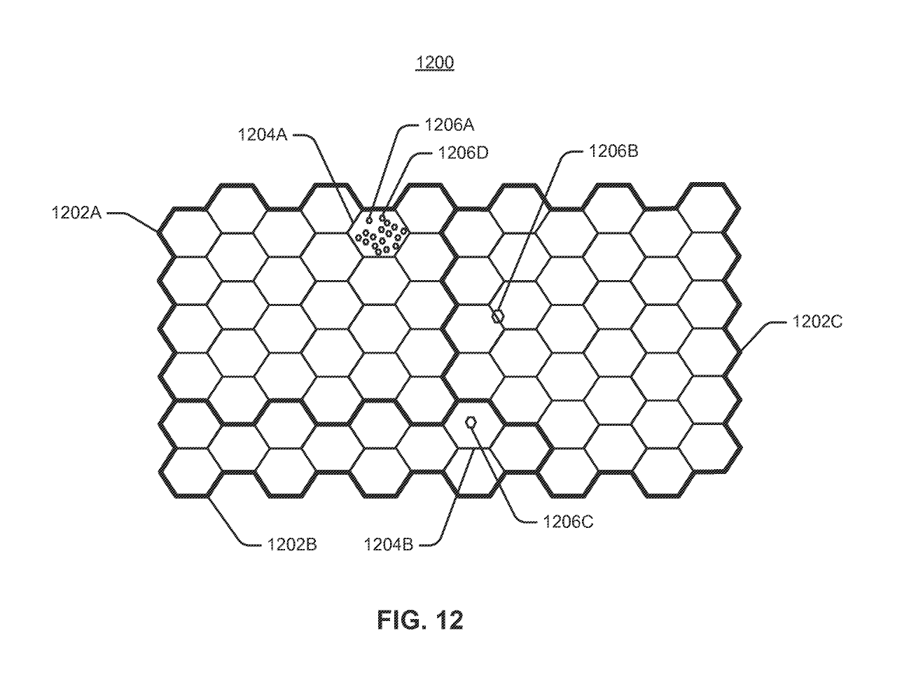

FIG. 12 illustrates an example of a coverage map 1200 where several tracking areas 1202 (or routing areas or location areas) are defined, each of which includes several macro coverage areas 1204. Here, areas of coverage associated with tracking areas 1202A, 1202B, and 1202C are delineated by the wide lines and the macro coverage areas 1204 are represented by the larger hexagons. The tracking areas 1202 also include femto coverage areas 1206. In this example, each of the femto coverage areas 1206 (e.g., femto coverage areas 1206B and 1206C) is depicted within one or more macro coverage areas 1204 (e.g., macro coverage areas 1204A and 1204B). It should be appreciated, however, that some or all of a femto coverage area 1206 might not lie within a macro coverage area 1204. In practice, a large number of femto coverage areas 1206 (e.g., femto coverage areas 1206A and 1206D) may be defined within a given tracking area 1202 or macro coverage area 1204. Also, one or more pico coverage areas (not shown) may be defined within a given tracking area 1202 or macro coverage area 1204.

Referring again to FIG. 11, the owner of a small cell 1110 may subscribe to mobile service, such as, for example, 3G mobile service, offered through the mobile operator core network 1150. In addition, an access terminal 1120 may be capable of operating both in macro environments and in smaller scale (e.g., residential) network environments. In other words, depending on the current location of the access terminal 1120, the access terminal 1120 may be served by a macro cell access point 1160 associated with the mobile operator core network 1150 or by any one of a set of small cells 1110 (e.g., the small cells 1110A and 1110B that reside within a corresponding user residence 1130). For example, when a subscriber is outside his home, he is served by a standard macro access point (e.g., access point 1160) and when the subscriber is at home, he is served by a small cell (e.g., small cell 1110A). Here, a small cell 1110 may be backward compatible with legacy access terminals 1120.

A small cell 1110 may be deployed on a single frequency or, in the alternative, on multiple frequencies. Depending on the particular configuration, the single frequency or one or more of the multiple frequencies may overlap with one or more frequencies used by a macro access point (e.g., access point 1160).

In some aspects, an access terminal 1120 may be configured to connect to a preferred small cell (e.g., the home small cell of the access terminal 1120) whenever such connectivity is possible. For example, whenever the access terminal 1120A is within the user's residence 1130, it may be desired that the access terminal 1120A communicate only with the home small cell 1110A or 1110B.

In some aspects, if the access terminal 1120 operates within the macro cellular network 1150 but is not residing on its most preferred network (e.g., as defined in a preferred roaming list), the access terminal 1120 may continue to search for the most preferred network (e.g., the preferred small cell 1110) using a better system reselection (BSR) procedure, which may involve a periodic scanning of available systems to determine whether better systems are currently available and subsequently acquire such preferred systems. The access terminal 1120 may limit the search for specific band and channel. For example, one or more femto channels may be defined whereby all small cells (or all restricted small cells) in a region operate on the femto channel(s). The search for the most preferred system may be repeated periodically. Upon discovery of a preferred small cell 1110, the access terminal 1120 selects the small cell 1110 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 1110 that reside within the corresponding user residence 1130). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., 911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

For convenience, the disclosure herein describes various functionality in the context of a small cell. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

FIG. 13 illustrates a wireless device 1310 (e.g., an access point) and a wireless device 1350 (e.g., an access terminal) of a sample MIMO system 1300. At the device 1310, traffic data for a number of data streams is provided from a data source 1312 to a transmit (TX) data processor 1314. Each data stream may then be transmitted over a respective transmit antenna.

The TX data processor 1314 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1330. A data memory 1332 may store program code, data, and other information used by the processor 1330 or other components of the device 1310.

The modulation symbols for all data streams are then provided to a TX MIMO processor 1320, which may further process the modulation symbols (e.g., for OFDM). The TX MIMO processor 1320 then provides N_{T} modulation symbol streams to N_{T} transceivers (XCVR) 1322A through 1322T. In some aspects, the TX MIMO processor 1320 applies beam-forming weights to the symbols of the data streams and to the antenna from which the symbol is being transmitted.

Each transceiver 1322 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1322A through 1322T are then transmitted from N_{T} antennas 1324A through 1324T, respectively.

At the device 1350, the transmitted modulated signals are received by N_{R} antennas 1352A through 1352R and the received signal from each antenna 1352 is provided to a respective transceiver (XCVR) 1354A through 1354R. Each transceiver 1354 conditions (e.g., filters, amplifies, and downconverts) a respective received signal, digitizes the conditioned signal to provide samples, and further processes the samples to provide a corresponding “received” symbol stream.

A receive (RX) data processor 1360 then receives and processes the N_{R} received symbol streams from N_{R} transceivers 1354 based on a particular receiver processing technique to provide N_{T} “detected” symbol streams. The RX data processor 1360 then demodulates, deinterleaves, and decodes each detected symbol stream to recover the traffic data for the data stream. The processing by the RX data processor 1360 is complementary to that performed by the TX MIMO processor 1320 and the TX data processor 1314 at the device 1310.

A processor 1370 periodically determines which pre-coding matrix to use (discussed below). The processor 1370 formulates a reverse link message comprising a matrix index portion and a rank value portion. A data memory 1372 may store program code, data, and other information used by the processor 1370 or other components of the device 1350.

The reverse link message may comprise various types of information regarding the communication link and/or the received data stream. The reverse link message is then processed by a TX data processor 1338, which also receives traffic data for a number of data streams from a data source 1336, modulated by a modulator 1380, conditioned by the transceivers 1354A through 1354R, and transmitted back to the device 1310.

At the device 1310, the modulated signals from the device 1350 are received by the antennas 1324, conditioned by the transceivers 1322, demodulated by a demodulator (DEMOD) 1340, and processed by a RX data processor 1342 to extract the reverse link message transmitted by the device 1350. The processor 1330 then determines which pre-coding matrix to use for determining the beam-forming weights then processes the extracted message.

FIG. 13 also illustrates that the communication components may include one or more components that perform advertisement (AD) control operations as taught herein. For example, an AD control component 1390 may cooperate with the processor 1330 and/or other components of the device 1310 to broadcast an AD to another device (e.g., device 1350) as taught herein. In addition, an AD control component 1392 may cooperate with the processor 1370 and/or other components of the device 1350 to receive and process an AD received from another device (e.g., device 1310) as taught herein. It should be appreciated that for each device 1310 and 1350 the functionality of two or more of the described components may be provided by a single component. For example, a single processing component may provide the functionality of the AD control component 1390 and the processor 1330, and a single processing component may provide the functionality of the AD control component 1392 and the processor 1370.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

In view of the above, in some aspects a first apparatus for communication comprises: a communication device configured to receive a broadcast message at an access terminal while the access terminal is operating in idle mode; a processing system configured to extract an advertisement from the broadcast message; and a display device configured to display the advertisement.

In addition, in some aspects at least one of the following also may apply to the first apparatus for communication: the broadcast message comprises a system information block that includes the advertisement; the system information block comprises an HNB Name field that includes the advertisement; the broadcast message comprises an information block that is designated for carrying access point-specific information that is to be displayed; the broadcast message comprises a message broadcast independent of any broadcast of user data; the broadcast message is received via a broadcast channel; the broadcast message is received via a channel that is not used for transmission of user data; the broadcast message is received via a control channel; the processing system is further configured to: store the extracted advertisement, perform an operation involving cell selection or cell reselection, and retrieve the stored advertisement as a result of performing the operation, wherein the displaying of the advertisement comprises displaying the retrieved advertisement.

In view of the above, in some aspects a first method of communication comprises: receiving a broadcast message at an access terminal while the access terminal is operating in idle mode; extracting an advertisement from the broadcast message; and displaying the advertisement via a display device of the access terminal.

In addition, in some aspects at least one of the following also may apply to the first method of communication: the broadcast message comprises a system information block that includes the advertisement; the system information block comprises an HNB Name field that includes the advertisement; the broadcast message comprises an information block that is designated for carrying access point-specific information that is to be displayed; the broadcast message comprises a message broadcast independent of any broadcast of user data; the broadcast message is received via a broadcast channel; the broadcast message is received via a channel that is not used for transmission of user data; the broadcast message is received via a control channel; the method further comprises: storing the extracted advertisement, performing an operation involving cell selection or cell reselection, and retrieving the stored advertisement as a result of performing the operation, wherein the displaying of the advertisement comprises displaying the retrieved advertisement.

In view of the above, in some aspects a second apparatus for communication comprises: means for receiving a broadcast message at an access terminal while the access terminal is operating in idle mode; means for extracting an advertisement from the broadcast message; and means for displaying the advertisement via a display device of the access terminal.

In addition, in some aspects at least one of the following also may apply to the second apparatus for communication: the broadcast message comprises a system information block that includes the advertisement; the system information block comprises an HNB Name field that includes the advertisement; the broadcast message is received via a broadcast channel; the apparatus further comprises: means for storing the extracted advertisement, means for performing an operation involving cell selection or cell reselection, and means for retrieving the stored advertisement as a result of performing the operation, wherein the displaying of the advertisement comprises displaying the retrieved advertisement.

In view of the above, in some aspects a computer-program product comprises: computer-readable medium comprising code for causing a computer to: receive a broadcast message at an access terminal while the access terminal is operating in idle mode; extract an advertisement from the broadcast message; and display the advertisement via a display device of the access terminal.

In addition, in some aspects at least one of the following also may apply to the computer-program product: the broadcast message comprises a system information block that includes the advertisement; the system information block comprises an HNB Name field that includes the advertisement.

The functionality described herein (e.g., with regard to one or more of the accompanying figures) may correspond in some aspects to similarly designated “means for” functionality in the appended claims.

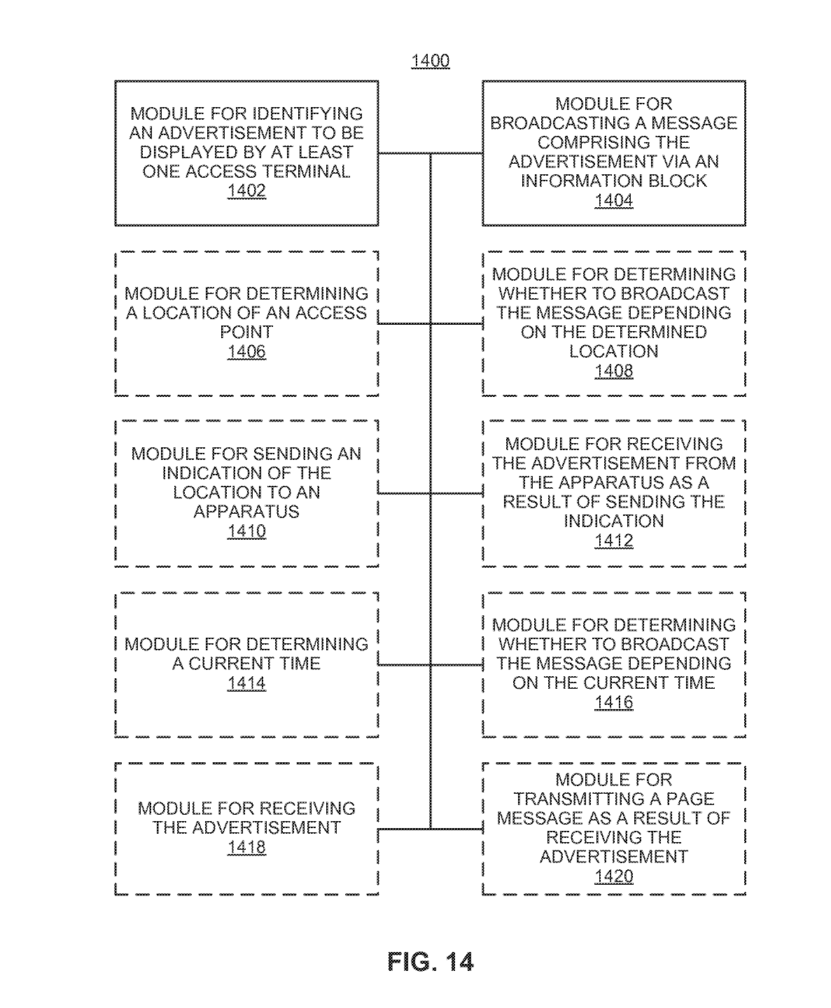

Referring to FIG. 14, an apparatus 1400 is represented as a series of interrelated functional modules. A module for identifying an advertisement to be displayed by at least one access terminal 1402 may correspond at least in some aspects to, for example, a processing system as discussed herein. A module for broadcasting a message comprising the advertisement via an information block 1404 may correspond at least in some aspects to, for example, a communication device (e.g., a transmitter) as discussed herein. A module for determining a location of an access point 1406 may correspond at least in some aspects to, for example, a processing system as discussed herein. A module for determining whether to broadcast the message depending on the determined location 1408 may correspond at least in some aspects to, for example, a processing system as discussed herein. A module for sending an indication of the location to an access point 1410 may correspond at least in some aspects to, for example, a communication device (e.g., a transmitter) as discussed herein. A module for receiving the advertisement from the apparatus as a result of sending the indication 1412 may correspond at least in some aspects to, for example, a communication device (e.g., a receiver) as discussed herein. A module for determining a current time 1414 may correspond at least in some aspects to, for example, a processing system as discussed herein. A module for determining whether to broadcast the message depending on the current time 1416 may correspond at least in some aspects to, for example, a processing system as discussed herein. A module for receiving the advertisement 1418 may correspond at least in some aspects to, for example, a communication device (e.g., a receiver) as discussed herein. A module for transmitting a page message as a result of receiving the advertisement 1420 may correspond at least in some aspects to, for example, a communication device (e.g., a transmitter) as discussed herein.

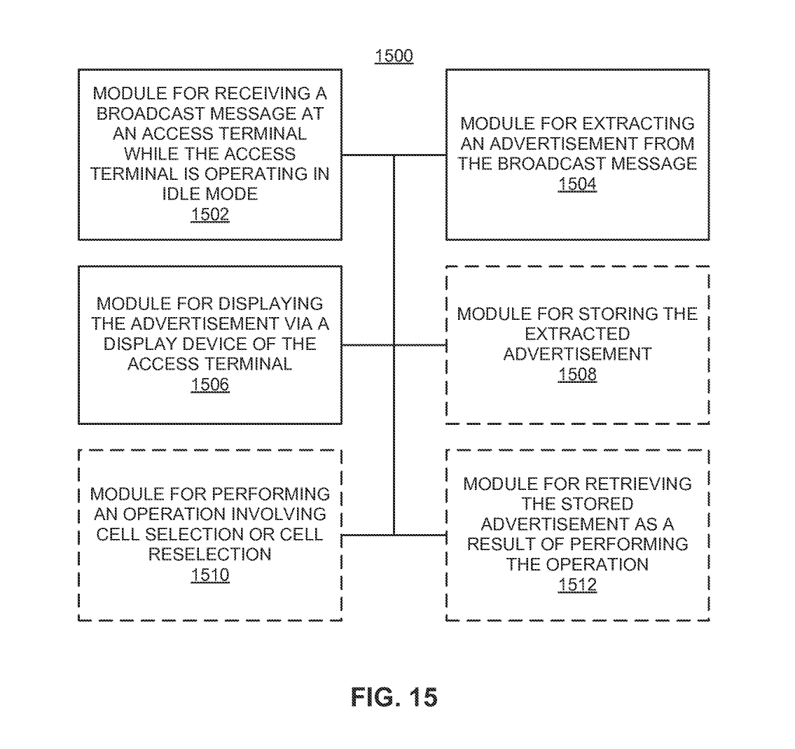

Referring to FIG. 15, an apparatus 1500 is represented as a series of interrelated functional modules. A module for receiving a broadcast message at an access terminal while the access terminal is operating in idle mode 1502 may correspond at least in some aspects to, for example, a communication device (e.g., a receiver) as discussed herein. A module for extracting an advertisement from the broadcast message 1504 may correspond at least in some aspects to, for example, a processing system as discussed herein. A module for displaying the advertisement via a display device of the access terminal 1506 may correspond at least in some aspects to, for example, a display device as discussed herein. A module for storing the extracted advertisement 1508 may correspond at least in some aspects to, for example, a processing system as discussed herein. A module for performing an operation involving cell selection or cell reselection 1510 may correspond at least in some aspects to, for example, a processing system as discussed herein. A module for retrieving the stored advertisement as a result of performing the operation 1512 may correspond at least in some aspects to, for example, a processing system as discussed herein.

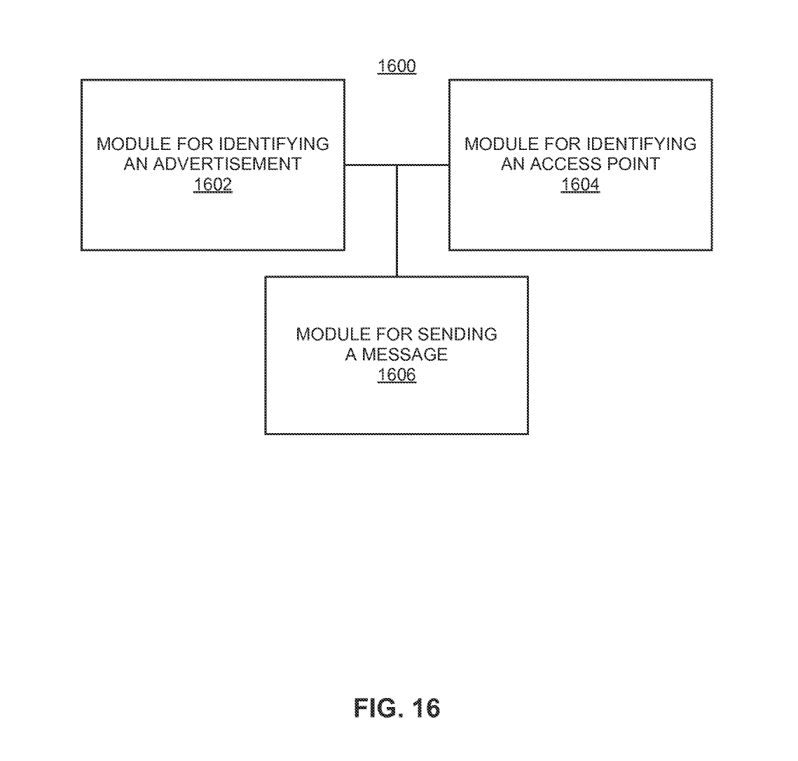

Referring to FIG. 16, an apparatus 1600 is represented as a series of interrelated functional modules. A module for identifying an advertisement 1602 may correspond at least in some aspects to, for example, a processing system as discussed herein. A module for identifying an access point 1604 may correspond at least in some aspects to, for example, a processing system as discussed herein. A module for sending a message 1606 may correspond at least in some aspects to, for example, a communication device (e.g., a transmitter) as discussed herein.

The functionality of the modules of FIGS. 14-16 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1500 may comprise a single device (e.g., components 1502-1512 comprising different sections of an ASIC). As another specific example, the apparatus 1500 may comprise several devices (e.g., the component 1502 comprising one ASIC, the component 1506 comprising another ASIC, and the components 1504, 1508, 1510, and 1512 comprising another ASIC). The functionality of these modules also may be implemented in some other manner as taught herein. In some aspects one or more of any dashed blocks in FIGS. 14-16 are optional.

In addition, the components and functions represented by FIGS. 14-16 as well as other components and functions described herein, may be implemented using any suitable means. Such means also may be implemented, at least in part, using corresponding structure as taught herein. For example, the components described above in conjunction with the “module for” components of FIGS. 14-16 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm operations described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of operations in any disclosed process is an example of a sample approach. Based upon design preferences, it is understood that the specific order or hierarchy of operations in the processes may be rearranged while remaining within the scope of the present disclosure. The accompanying method claims present elements of the various operations in a sample order, and are not meant to be limited to the specific order or hierarchy presented.

The operations of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more implementations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a processing system configured to identify, at an access point, an advertisement to be displayed by at least one access terminal associated with the access point; and
a communication device configured to broadcast, from the access point, a message via an information block that is designated for carrying access point-specific information that is to be displayed, wherein the message comprises the advertisement.

2. The apparatus of claim 1, wherein the information block comprises a system information block.

3. The apparatus of claim 2, wherein the information block comprises an HNB Name field of the system information block.

4. The apparatus of claim 1, wherein the identification of the advertisement comprises:
receiving the advertisement;
storing the received advertisement; and
determining that the stored advertisement is to be broadcast via the information block.

5. The apparatus of claim 1, wherein the processing system is further configured to:
determine a location of the access point; and
determine whether to broadcast the message depending on the determined location.

6. The apparatus of claim 1, wherein:
the processing system is further configured to determine a location of the access point;
the communication device is further configured to send an indication of the location to another apparatus; and
the communication device is further configured to receive the advertisement from the apparatus as a result of sending the indication.

7. The apparatus of claim 1, wherein the processing system is further configured to:
determine a current time; and
determine whether to broadcast the message depending on the current time.

8. The apparatus of claim 1, wherein the communication device is further configured to:
receive the advertisement; and
transmit a page message as a result of receiving the advertisement, wherein the page message indicates a change in a broadcast channel used by the access point for broadcasting the message.

9. A method of communication, comprising:
identifying, at an access point, an advertisement to be displayed by at least one access terminal associated with the access point; and
broadcasting, from the access point, a message via an information block that is designated for carrying access point-specific information that is to be displayed, wherein the message comprises the advertisement.

10. The method of claim 9, wherein the information block comprises a system information block.

11. The method of claim 10, wherein the information block comprises an HNB Name field of the system information block.

12. The method of claim 9, wherein the identification of the advertisement comprises:
receiving the advertisement;
storing the received advertisement; and
determining that the stored advertisement is to be broadcast via the information block.

13. The method of claim 9, further comprising:
determining a location of the access point; and
determining whether to broadcast the message depending on the determined location.

14. The method of claim 9, further comprising:
determining a location of the access point;
sending an indication of the location to an apparatus; and
receiving the advertisement from the apparatus as a result of sending the indication.

15. The method of claim 9, further comprising:
determining a current time; and
determining whether to broadcast the message depending on the current time.

16. The method of claim 9, further comprising:
receiving the advertisement; and
transmitting a page message as a result of receiving the advertisement, wherein the page message indicates a change in a broadcast channel used by the access point for broadcasting the message.

17. An apparatus for communication, comprising:
means for identifying, at an access point, an advertisement to be displayed by at least one access terminal associated with the access point; and
means for broadcasting, from the access point, a message via an information block that is designated for carrying access point-specific information that is to be displayed, wherein the message comprises the advertisement.

18. The apparatus of claim 17, wherein the information block comprises a system information block.

19. The apparatus of claim 18, wherein the information block comprises an HNB Name field of the system information block.

20. A computer-program product, comprising:
computer-readable medium comprising code for causing a computer to:
identify, at an access point, an advertisement to be displayed by at least one access terminal associated with the access point; and
broadcast, from the access point, a message via an information block that is designated for carrying access point-specific information that is to be displayed, wherein the message comprises the advertisement.

21. The computer-program product of claim 20, wherein the information block comprises a system information block.

22. The computer-program product of claim 21, wherein the information block comprises an HNB Name field of the system information block.

23. An apparatus for communication, comprising:
a processing system configured to identify an advertisement, and further configured to identify an access point that is to broadcast the advertisement; and
a communication device configured to send a message to the access point, wherein the message includes the advertisement, and wherein the message indicates that the advertisement is to be broadcast via an information block that is designated for carrying access point-specific information that is to be displayed.

24. The apparatus of claim 23, wherein the information block comprises a system information block.

25. The apparatus of claim 24, wherein the message further indicates that the advertisement is to be broadcast via an HNB Name field of the system information block.

26. The apparatus of claim 23, wherein the identification of the advertisement is based on a current time or an advertisement broadcast time.

27. The apparatus of claim 23, wherein the identification of the access point is based on a location of the access point.

28. A method of communication, comprising:
identifying an advertisement;
identifying an access point that is to broadcast the advertisement; and
sending a message to the access point, wherein the message includes the advertisement, and wherein the message indicates that the advertisement is to be broadcast via an information block that is designated for carrying access point-specific information that is to be displayed.

29. The method of claim 28, wherein the information block comprises a system information block.

30. The method of claim 29, wherein the message further indicates that the advertisement is to be broadcast via an HNB Name field of the system information block.

31. The method of claim 28, wherein the identification of the advertisement is based on a current time or an advertisement broadcast time.

32. The method of claim 28, wherein the identification of the access point is based on a location of the access point.

33. An apparatus for communication, comprising:
means for identifying an advertisement;
means for identifying an access point that is to broadcast the advertisement; and
means for sending a message to the access point, wherein the message includes the advertisement, and wherein the message indicates that the advertisement is to be broadcast via an information block that is designated for carrying access point-specific information that is to be displayed.

34. The apparatus of claim 33, wherein the information block comprises a system information block.

35. The apparatus of claim 34, wherein the message further indicates that the advertisement is to be broadcast via an HNB Name field of the system information block.

36. A computer-program product, comprising:
computer-readable medium comprising code for causing a computer to:
identify an advertisement;
identify an access point that is to broadcast the advertisement; and
send a message to the access point, wherein the message includes the advertisement, and wherein the message indicates that the advertisement is to be broadcast via an information block that is designated for carrying access point-specific information that is to be displayed.

37. The computer-program product of claim 36, wherein the information block comprises a system information block.

38. The computer-program product of claim 37, wherein the message further indicates that the advertisement is to be broadcast via an HNB Name field of the system information block.
